(19) United States
(12) Patent Application Publication
(10) Pub. No.: US 2013/0124867 A1
(43) Pub. Date: May 16, 2013

(54) SYSTEM AND METHOD FOR SECURE SOFTWARE LICENSE DISTRIBUTION

(71) Applicant: NL Systems, LLC, Frisco, TX (US)

(72) Inventors: William P. Clayton, II, Little Elm, TX (US); Brandon Hart, Rockwall, TX (US); Courtney Roach, Frisco, TX (US); Patryck Thomas, Plano, TX (US); John Gilmore, Seattle, WA (US); Terry Stephenson, Rockwall, TX (US)

(73) Assignee: NL SYSTEMS, LLC, Frisco, TX (US)

(21) Appl. No.: 13/678,235

(22) Filed: Nov. 15, 2012

Related U.S. Application Data
(60) Provisional application No. 61/560,389, filed on Nov. 16, 2011.

(51) Int. Cl. H04L 9/32

(52) U.S. Cl. CPC H04L 9/32
USPC 713/171

(57) ABSTRACT

In one embodiment, a method includes receiving a request to remove one or more limitations imposed on a full-featured base application executing on a client computer. The method further includes creating a license package. The license package includes a first layer and a second layer separately encrypted therein. The second layer includes a license key operable to be consumed by the full-featured base application to remove the one or more limitations. The first layer comprises information sufficient to identify the license key. In addition, the method includes encapsulating the license package into a file having a file-type association with the full-featured base application. Further, the method includes transmitting the file to the client computer. The method also includes interacting with the full-featured base application to allow decryption of the first layer and the second layer so that the license key can be applied.

### CROSS-REFERENCE TO RELATED APPLICATIONS

This patent application claims priority from, and incorporates by reference the entire disclosure of, U.S. Provisional Patent Application No. 61/560,389 filed on Nov. 16, 2011. U.S. Patent Publication No. 2005/0229258 and U.S. Patent Publication No. 2007/0074270 are incorporated by reference herein in their entirety.

### BACKGROUND

1. Technical Field

The present invention relates generally to the field of software security, and more particularly, but not by way of limitation, to a system and method for facilitating secure software license distribution.

2. History Of Related Art

The unauthorized copying and use of software, often called software piracy, is a longstanding problem in the software industry. Software vendors commonly attempt to prevent software piracy through the use of product keys. A product key, sometimes referred to as a software key, is a specific software-based key for a computer program. It certifies that the copy of the program is original. Activation is sometimes done offline by entering the key, or with some software online activation is required to prevent multiple people using the same key.

However, product keys are somewhat inconvenient for end users. Not only do they need to be entered whenever a program is installed, but the user must also be sure not to lose them. Loss of a product key usually means the software is useless once uninstalled. In addition, product keys also present new ways for distribution to go wrong. If a product is shipped with missing or invalid keys, then the product itself is useless. Additionally, software products are generally vulnerable to cracks that attempt to remove security-protection methods such as, for example, the requirement for a product key.

Currently-used systems and methods for fighting software piracy such as, for example, the use of product keys as described above, are insufficient. Despite continued efforts to stem the tide, software piracy continues to proliferate. According to studies conducted jointly by the Business Software Alliance (BSA) and International Data Corporation (IDC), in 2009 losses from software piracy exceeded $51 billion. Clearly, more effective and more secure methods for securing software are needed.

### SUMMARY OF THE INVENTION

In one embodiment, a method includes receiving, on a computer system comprising at least one server computer, a request to remove one or more limitations imposed on a full-featured base application executing on a client computer. The request includes a user signature and a hardware fingerprint. The method further includes creating, by the computer system, a license package. The license package includes a first layer and a second layer separately encrypted therein. The second layer includes a license key operable to be consumed by the full-featured base application to remove the one or more limitations. The first layer comprises information sufficient to identify the license key. In addition, the method includes encapsulating, by the computer system, the license package into a file having a file-type association with the full-featured base application. Further, the method includes transmitting, by the computer system, the file to the client computer. The method also includes the computer system interacting with the full-featured base application to allow decryption of the first layer and the second layer so that the license key can be applied. The interacting includes verifying a user of the client computer, hardware of the client computer, and the license key.

In one embodiment, a method includes transmitting, by a client computer, a request to remove one or more limitations imposed on a full-featured base application. The request includes a user signature and a hardware fingerprint. The method further includes receiving a file having a file-type association with the full-featured base application. The file encapsulates a license package. The license package includes a first layer and a second layer separately encrypted therein. The second layer includes a license key operable to be consumed by the full-featured base application to remove the one or more limitations. The first layer includes information sufficient to identify the license key. In addition, the method includes the client computer interacting with a secure computer system to decrypt the first layer and the second layer. Furthermore, the method includes applying the license key to the full-featured base application.

In one embodiment, a system includes a license server, an authentication server, an email server, and a secure network. The license server is operable to create and verify license keys. The authentication server is operable to authenticate users and client-computer hardware. The email server is operable to transmit emails. The secure network is for enabling communication among the license server, the authentication server, and the email server. The system is operable to receive a request to remove one or more limitations imposed on a full-featured base application executing on a client computer. The request includes a user signature and a hardware fingerprint. The system is further operable to create a license package, the license package comprising a first layer and a second layer separately encrypted therein. The second layer includes a license key operable to be consumed by the full-featured base application to remove the one or more limitations. The first layer includes information sufficient to identify the license key. In addition, the system is operable to encapsulate the license package into a file having a file-type association with the full-featured base application. Additionally, the system is operable to transmit the file to the client computer. Furthermore, the system is operable to interact with the full-featured base application to allow decryption of the first layer and the second layer so that the license key can be applied. The interaction comprises verification of a user of the client computer, hardware of the client computer, and the license key.

In one embodiment, a computer-program product includes a computer-usable medium having computer-readable program code embodied therein, the computer-readable program code adapted to be executed to implement a method. The method includes receiving a request to remove one or more limitations imposed on a full-featured base application executing on a client computer. The request includes a user signature and a hardware fingerprint. The method further includes creating a license package. The license package includes a first layer and a second layer separately encrypted therein. The second layer includes a license key operable to be consumed by the full-featured base application to remove the one or more limitations. The first layer comprises information sufficient to identify the license key. In addition, the method includes encapsulating the license package into a file having a file-type association with the full-featured base application. Further, the method includes transmitting the file to the client computer. The method also includes interacting with the full-featured base application to allow decryption of the first layer and the second layer so that the license key can be applied. The interacting includes verifying a user of the client computer, hardware of the client computer, and the license key.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a system 100 that facilitates secure software license distribution; and

FIG. 2 illustrates a process for secure software license distribution using the system of FIG. 1.

### DETAILED DESCRIPTION OF ILLUSTRATIVE EMBODIMENTS OF THE INVENTION

In various embodiments, the unauthorized use of software can be prevented via a system and method that performs server-side authentication of a user, of the computer hardware that the user uses, and of the user's email address. Furthermore, in various embodiments, software license distribution can be made more effective by eliminating a requirement for an end user to view and enter a product key. Rather, as described in greater detail below, a full-featured base application can be configured to self-consume a license key via a file encapsulation that has a file-type association with the base application.

For purposes of this patent application, a base application may be considered an underlying software application that provides functionality desirous to an end user.

For example, a base application may be a word-processing application, a secure email application, a video-editing application, or any other software application that can operate in a given computing environment. In various embodiments, a base application may be a full-featured application that has at least one limitation imposed thereon.

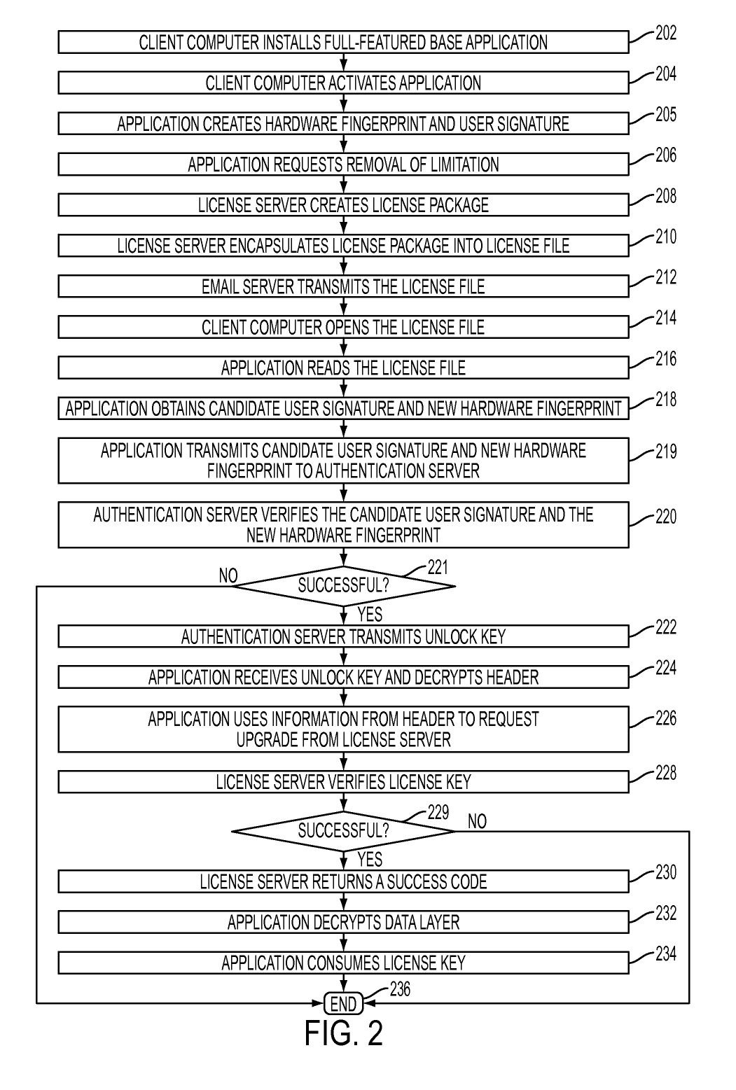

For purposes of this patent application, a full-featured base application is a base application that has all content (e.g., programs, libraries, and files) necessary to perform the full functionality intended by a software vendor. In various embodiments, a limitation may be imposed on a full-featured base application by the software vendor. For example, a full-featured base application may have one or more features disabled or have a use-based limitation such as, for example, an expiration date after which the software will no longer operate. A full-featured base application may also be limited to the point that all features are disabled so that the full-featured base application is functionless. To the extent a full-featured base application has limitations imposed by the software vendor, the limitations may only be removed only by a proper licensing and unlocking procedure. An example of a proper licensing and unlocking procedure using a license key is described with respect to FIG. 2. As used herein, a license key is a key, code, or file that serves to unlock a limitation imposed on a full-featured base application.

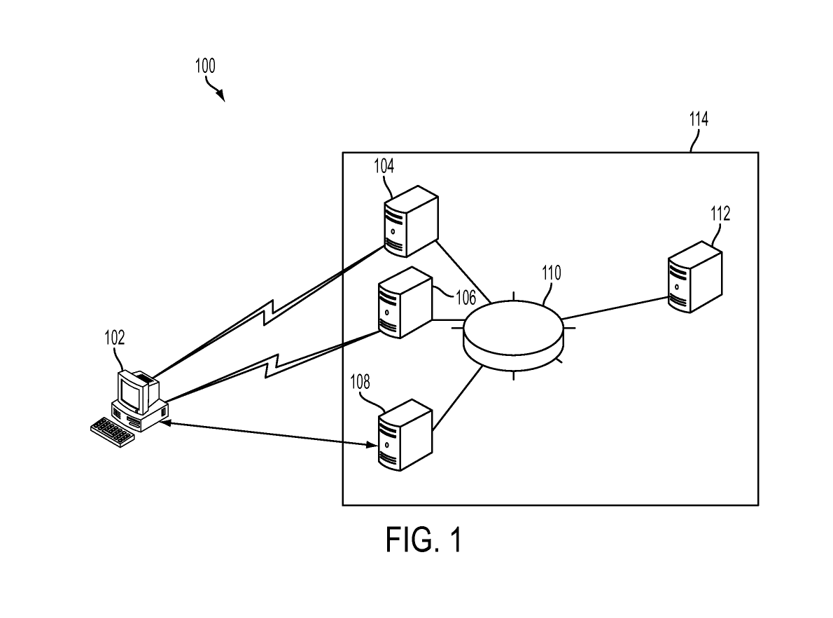

FIG. 1 illustrates a system 100 that facilitates secure software license distribution. The system 100 includes a client computer 102 and a secure computer system 114. The secure computer system 114 includes an authentication server 104, an email server 106, a license server 108, and a database server 112. As described in more detail below, the authentication server 104, the email server 106, the license server 108, and the database server 112 collectively provide a secure infrastructure that can be utilized to securely distribute a license key to the client computer 102.

The authentication server 104 is operable to perform functionality to authenticate, for example, users and user computer hardware. In a typical embodiment, the license server 108 is operable to manage and assign license keys to specific users and user hardware. Typically, the license server 108 can also verify authenticity of license keys. The database server 112 securely stores data to support the authentication server 104 and the license server 108. In various embodiments, the data stored by the database server 112 may be encrypted. In a typical embodiment, the email server 106 is used transmit secure emails, for example, to users of the client computer 102. The client computer 102 may be, for example, a desktop computer, a laptop computer, a smartphone, or the like.

In a typical embodiment, the authentication server, the email server 106, the license server 108, and the database server communicate over the secure network 100 via encrypted communication according to a predetermined encryption protocol. Moreover, in a typical embodiment, all communication between the client computer 102 and either the authentication server 104 or the license server 108 is encrypted communication according to the predetermined encryption protocol. Examples of encryption protocols that may be utilized are described in U.S. Patent Publication No. 2005/0229258 and U.S. Patent Publication No. 2007/0074270, which publications are incorporated herein by reference. Operation of the system 100 will be described in greater detail with respect to FIG. 2.

For purposes of illustration, various computers or computer systems are illustrated in FIG. 1 such as, for example, the authentication server 104, the email server 106, the license server 108, and the database server 112. One of ordinary skill in the art will appreciate that each instance of a computer or computer system may, in various embodiments, represent a plurality of physical or virtual server computers. Likewise, although various server computers are illustrated separately in FIG. 1, in various embodiments, fewer physical or virtual server computers may be utilized. For example, in various embodiments, the authentication server 104 and the license server 108 may be resident and operating on one physical or virtual server computer.

FIG. 2 illustrates a process 200 for secure software-license distribution using the system 100 of FIG. 1. The process 200 will be described with reference to the system 100 of FIG. 1. The process 200 begins with step 202.

At step 202, responsive to prompting from a user, the client computer 102 installs a full-featured base application. In various embodiments, the full-featured base application may be downloaded from the Internet, installed from a computer-readable medium such as a CD or DVD, or the like. For purposes of FIG. 2, the full-featured base application may be assumed to at least one limitation imposed thereon by the software vendor such as, for example, at least one disabled feature or a use-based limitation. From step 202, the process 200 proceeds to step 204.

At step 204, responsive to prompting from the user, the client computer 102 activates the full-featured base application, for example, during an initial run. From step 204, the process 200 proceeds to step 205. At step 205, the full-featured base application creates a hardware fingerprint for the client computer 102 and a user signature for the user. The hardware fingerprint includes various attributes that, either by themselves or in combination with other attributes, uniquely identify the client computer 102. For example, the hardware fingerprint may include a BIOS version number, a video card BIOS creation date, a primary hard drive serial number, and other similar information. To create the user signature, the full-featured base application requests information from the user. The requested information (and the user signature) may include, for example, an email address and a password. From step 205, the process 200 proceeds to step 206.

At step 206, responsive to prompting from the user, the full-featured base application requests removal of one or more limitations from the license server 108. For example, the user may request that a disabled feature of the full-featured application be enabled. In various embodiments, the request may occur in conjunction with payment for the feature or for the “full version” of the full-featured application (i.e., removal of all limitations, including enablement of all disabled features). From step 206, the process 200 proceeds to step 208.

At step 208, the license server 108 creates a license package for the full-featured base application. In a typical embodiment, the license package includes a header layer and a data layer. The header layer includes the user signature, the hardware fingerprint, a special activation code (i.e., a code identifying the license key), and a list of the one or more limitations to be removed. The data layer includes a license key operable, once consumed by the full-featured base application, to remove the listed limitations (e.g., enable certain features). In a typical embodiment, the license server 108 generates and/or assigns the license key to the user signature and the hardware fingerprint. In a typical embodiment, the header layer and the data layer are encrypted using two different methodologies requiring two different unlock keys in order to decrypt. From step 208, the process 200 proceeds to step 210.

At step 210, the license server 108 encapsulates the license package into a license file is having a file-type association with the full-featured base application. In other words, if the full-featured base application is associated with and designed to open file types having a particular file extension (e.g. “*.safe”), the license file will have that same file extension. From step 210, the process 200 proceeds to step 212. At step 212, the email server 106 transmits the license file to the user's email address as an email attachment. Because access to the user's email is necessary to access the license file, the user's email address (as part of the user signature) may be deemed authenticated once the license file is opened. From step 212, the process 200 proceeds to step 214.

At step 214, responsive to user prompting, the client computer 102 opens the email attachment. Because the license file has a file extension associated with the full-featured base application, opening the license file automatically launches the full-featured base application. From step 214, the process 200 proceeds to step 216. At step 216, the full-featured base application reads the format of the license file. At this point, the full-featured base application recognizes that the license file is not an ordinary file to be opened or viewed but rather a request to upgrade. From step 216, the process 200 proceeds to step 218.

At step 218, the full-featured base application obtains a candidate user signature and a new hardware fingerprint for the client computer 102. In some embodiments, the candidate user signature may be obtained by prompting the user for the user password. In other embodiments, the candidate signature may be stored and available to be retrieved (e.g., the user may have a stored certificate). In still other embodiments, it is possible that no candidate user signature is obtained and the user signature may be deemed authenticated by the user having access to the email attachment. From step 218, the process 200 proceeds to step 219.

At step 219, any candidate user signature and the new hardware fingerprint are transmitted to the authentication server 104 for authentication. In various embodiments, the full-featured base application may additionally transmit the encrypted header to the authentication server 104 to serve as a basis for the authentication. From step 219, the process 200 proceeds to step 220. At step 220, the authentication server 104 verifies the candidate user signature against the user signature obtained at step 205 and the new hardware fingerprint against the hardware fingerprint obtained at step 205. From step 220, the process 200 proceeds to step 221. At step 221, it is determined whether the verification was successful. If not, the process 200 proceeds to step 236 and ends in failure. If it is determined at step 221 that the verification was successful, the process 200 proceeds to step 222. At step 222, the authentication server 104 transmits a single-use unlock key to the full-featured base application. From step 222, the process 200 proceeds to step 224.

At step 224, the full-featured base application receives the single-use unlock key and decrypts the header of the license file to retrieve, for example, the user signature, the hardware fingerprint, the special activation code, and the list of the one or more limitations to be removed. From step 224, the process 200 proceeds to step 226. At step 226, the full-featured base application uses information from the header layer to request upgrade from the license server 108. In particular, as part of the request, the full-featured base application sends the user signature, the hardware fingerprint, the special activation code, and the list of features to be enabled to the license server 108. From step 226, the process 200 proceeds to step 228.

At step 228, the license server 108 verifies the license key via the special activation code, the user signature, and the hardware fingerprint. As noted above, the special activation code identifies the license key. The license server 108 verifies the authenticity of the license key by comparing the list of the one or more limitations, the user signature, and the hardware fingerprint with corresponding stored information for that special activation code. From step 228, the process 200 proceeds to step 229. At step 229, it is determined whether the verification at step 228 was successful. If not, the process 200 proceeds to step 236 and ends in failure. If it is determined at step 229 that the verification was successful, the process 200 proceeds to step 230. At step 230, the license server 108 returns a success code to the full-featured base application. From step 230, the process 200 proceeds to step 232.

At step 232, the full-featured base application uses the success code (which is an unlock key) to decrypt the data layer of the license file and thus obtain the license key. From step 232, the process 200 proceeds to step 234. At step 234, the full-featured base application self-consumes the license key and activates/upgrades itself so that the one or more limitations are removed. In a typical embodiment, the license key is for a one-time use (as managed by the license server 108) and is never presented in readable form to the user. After step 234, the process 200 proceeds to step 236 and ends.

One of ordinary skill in the art will appreciate that the process 200 described above occurs transparently to a user of a client computer such as, for example, the client computer 102 of FIG. 1. Once the license file is opened as an email attachment, the full-featured base application handles the steps of the process 200 and the eventual self-upgrade.

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method comprising:
receiving, on a computer system comprising at least one server computer, a request to remove one or more limitations imposed on a full-featured base application executing on a client computer;
wherein the request comprises a user signature and a hardware fingerprint;
creating, by the computer system, a license package, the license package comprising a first layer and a second layer separately encrypted therein;
wherein the second layer comprises a license key operable to be consumed by the full-featured base application to remove the one or more limitations;
wherein the first layer comprises information sufficient to identify the license key;
encapsulating, by the computer system, the license package into a file having a file-type association with the full-featured base application;
transmitting, by the computer system, the file to the client computer;
the computer system interacting with the full-featured base application to allow decryption of the first layer and the second layer so that the license key can be applied; and
wherein the interacting comprises verifying a user of the client computer, hardware of the client computer, and the license key.

2. The method of claim 1, wherein the interacting comprises:
receiving a candidate user signature and a new hardware fingerprint;
verifying the candidate user signature and the new hardware fingerprint against the user signature and the hardware fingerprint, respectively; and
responsive to the verifying, transmitting an unlock key, the unlock key operable to decrypt the first layer.

3. The method of claim 2, wherein the interacting comprises:
receiving information decrypted from the first layer;
verifying the license key via the information; and
responsive to the verifying, returning a success code operable to decrypt the second layer.

4. The method of claim 1, wherein the transmitting comprises transmitting the file to an email address associated with the user as an email attachment.

5. The method of claim 1, wherein the first layer comprises the user signature, the hardware fingerprint, an activation code identifying the license key, and a list of the one or more limitations.

6. A method comprising:
transmitting, by a client computer, a request to remove one or more limitations imposed on a full-featured base application;
wherein the request comprises a user signature and a hardware fingerprint;
receiving a file having a file-type association with the full-featured base application, the file encapsulating a license package;
wherein the license package comprises a first layer and a second layer separately encrypted therein;
wherein the second layer comprises a license key operable to be consumed by the full-featured base application to remove the one or more limitations;
wherein the first layer comprises information sufficient to identify the license key;
the client computer interacting with a secure computer system to decrypt the first layer and the second layer; and
applying the license key to the full-featured base application.

7. The method of claim 6, wherein the interacting comprises:
obtaining a candidate user signature and a new hardware fingerprint;
transmitting the candidate user signature and the new hardware fingerprint to a secure computer system for authentication; and
receiving an unlock key, the unlock key operable to decrypt the first layer.

8. The method of claim 8, wherein the interacting comprises decrypting the first layer.

9. The method of claim 8, wherein the interacting comprises:
transmitting information decrypted from the first layer to the secure computer system; and
receiving a success code operable to decrypt the second layer.

10. The method of claim 9, wherein the interacting comprises decrypting the second layer to obtain the license key.

11. The method of claim 6, wherein the receiving comprises receiving the file via an email address associated with a user of the client computer.

12. The method of claim 6, wherein the applying comprises the full-featured base application self-consuming the license key.

13. A system comprising:
a license server operable to create and verify license keys;
an authentication server operable to authenticate users and client-computer hardware;
an email server operable to transmit emails;
a secure network for enabling communication among the license server, the authentication server, and the email server; and
wherein the license server, the authentication server, and the email server, in combination, are operable to:
receive a request to remove one or more limitations imposed on a full-featured base application executing on a client computer;
wherein the request comprises a user signature and a hardware fingerprint;
create a license package, the license package comprising a first layer and a second layer separately encrypted therein;
wherein the second layer comprises a license key operable to be consumed by the full-featured base application to remove the one or more limitations;
wherein the first layer comprises information sufficient to identify the license key;
encapsulate the license package into a file having a file-type association with the full-featured base application; and
transmit the file to the client computer;
interact with the full-featured base application to allow decryption of the first layer and the second layer so that the license key can be applied; and
wherein the interaction comprises verification of a user of the client computer, hardware of the client computer, and the license key.

14. The system of claim 13, wherein the interaction comprises:
receipt of a candidate user signature and a new hardware fingerprint;
verification of the candidate user signature and the new hardware fingerprint against the user signature and the hardware fingerprint, respectively; and
responsive to the verification, transmission of an unlock key, the unlock key operable to decrypt the first layer.

15. The system of claim 14, wherein the interaction comprises:
receipt of information decrypted from the first layer;
verification of the license key via the information; and
responsive to the verification, return of a success code operable to decrypt the second layer.

16. The system of claim 13, wherein the transmission comprises transmission of the file to an email address associated with the user as an email attachment.

17. The system of claim 13, wherein the first layer comprises the user signature, the hardware fingerprint, an activation code identifying the license key, and a list of the one or more limitations.

18. A computer-program product comprising a computer-usable medium having computer-readable program code embodied therein, the computer-readable program code adapted to be executed to implement a method comprising:
receiving a request to remove one or more limitations imposed on a full-featured base application executing on a client computer;
wherein the request comprises a user signature and a hardware fingerprint;
creating a license package, the license package comprising a first layer and a second layer separately encrypted therein;
wherein the second layer comprises a license key operable to be consumed by the full-featured base application to remove the one or more limitations;
wherein the first layer comprises information sufficient to identify the license key;
encapsulating the license package into a file having a file-type association with the full-featured base application;
transmitting the file to the client computer;
interacting with the full-featured base application to allow decryption of the first layer and the second layer so that the license key can be applied; and
wherein the interacting comprises verifying a user of the client computer, hardware of the client computer, and the license key.

19. The computer-program product of claim 18, wherein the interacting comprises:
receiving a candidate user signature and a new hardware fingerprint;
verifying the candidate user signature and the new hardware fingerprint against the user signature and the hardware fingerprint, respectively; and
responsive to the verifying, transmitting an unlock key, the unlock key operable to decrypt the first layer.

20. The computer-program product of claim 19, wherein the interacting comprises:
receiving information decrypted from the first layer;
verifying the license key via the information; and
responsive to the verifying, returning a success code operable to decrypt the second layer.
